(19) United States
(12) Patent Application Publication
(10) Pub. No.: US 2016/0101617 A1
(43) Pub. Date: Apr. 14, 2016

(54) FUSED DEPOSITION MODELING INCLUDING COLOR APPLIED TO A DEPOSITED BEAD

(71) Applicant: Charles J. Kulas, San Francisco, CA (US)

(72) Inventor: Charles J. Kulas, San Francisco, CA (US)

(21) Appl. No.: 14/882,365

(22) Filed: Oct. 13, 2015

Related U.S. Application Data
(60) Provisional application No. 62/062,826, filed on Oct. 10, 2014.
(60) Provisional application No. 62/063,735, filed on Oct. 14, 2014.

(51) Int. Cl. B41J 2/01; B29B 11/04

(52) U.S. Cl. CPC B41J 2/01; B29B 11/04; B33Y 30/00

(57) ABSTRACT

Embodiments generally relate to a system for color printing on 3D printed objects. In one embodiment, a ring of ink jet emitters is positioned around an extruder head but out of the build plane. By coordinated emission of ink that is focused on one or more portions of a bead of material deposited by a 3D printer head, colored points can be created on the surface of the bead or “road” formed by successive or continuous deposition of material by the extruder head.

### CROSS REFERENCES TO RELATED APPLICATIONS

This application claims priority from U.S. Provisional Patent Application Ser. No. 62/062,826, entitled COLOR 3D PRINTING, filed on Oct. 10, 2014 and U.S. Provisional Patent Application Ser. No. 62/063,735, entitled COLOR 3D PRINTING, filed on Oct. 14, 2014, which are hereby incorporated by reference as if set, forth in full in this application for all purposes.

### SUMMARY

Embodiments generally relate to a system for color printing on 3D printed objects. In one embodiment, a ring of ink jet emitters is positioned around an extruder head but out of the build plane. By coordinated emission of ink that is focused on one or more portions of a bead of material deposited by a 3D printer head, colored points can be created on the surface of the bead or “road” formed by successive or continuous deposition of material by the extruder head.

### BRIEF DESCRIPTION OF THE DRAWINGS

FIG. 1 illustrates a simplified cutaway view of components in a 3D color printing system;

FIG. 2 shows a section of a section of a spherical printing head;

FIG. 3 is a simplified diagram of a control system for color 3D printing;

FIG. 4 shows a cross sectional view of 4 layers of extruded beads including color areas.

### DETAILED DESCRIPTION

Embodiments described herein are merely illustrative examples showing basic components and other features. It should be apparent that many other variations of these features are possible that can provide additional embodiments that may fall within the scope of the claims.

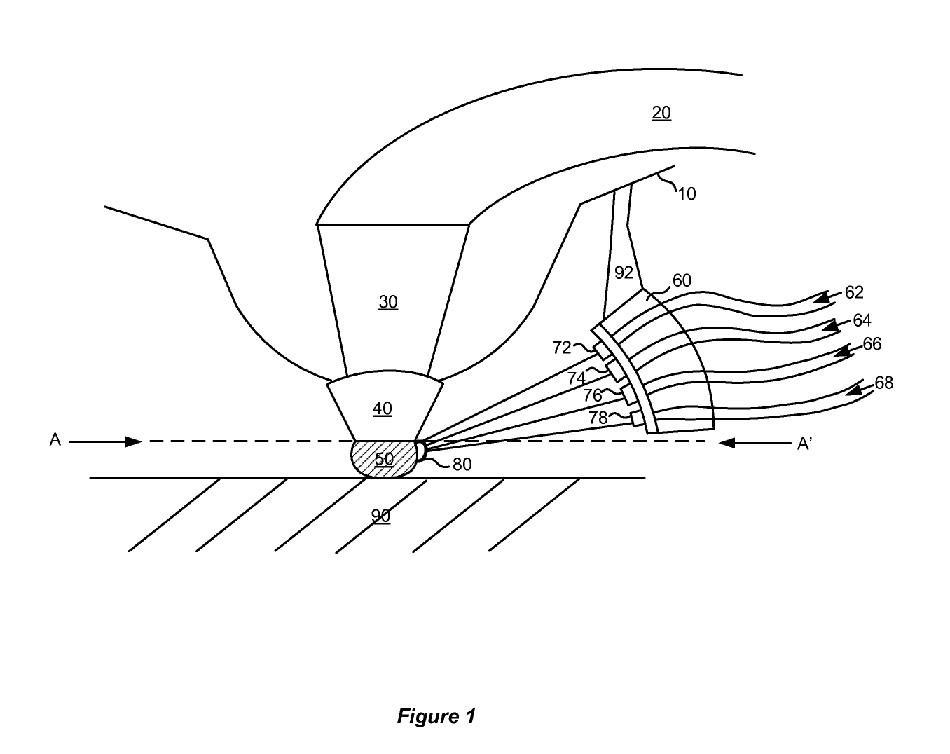

FIG. 1 illustrates a simplified cutaway view of components in a 3D color printing system. In FIG. 1, filament 20 is fed through a feeder mechanism (not shown) in a Fused Deposition Model (FDM) form of additive manufacturing or “3D printing.” Although specific types of 3D printing or additive manufacturing may be described, features presented herein may be useful and applied in other types of 3D printing. Filament 20 is fed through a hot end 30 to be extruded out of the tip of nozzle 40 as a “bead” 50 of material which then hardens quickly to form a solid structure. Surface 90 can be the “bed” or platform of the 3D printer or surface 90 can be an existing layer of extruded material or other material.

In one embodiment, printer head 60 is an inkjet printer head and includes jets 72, 74, 76 and 78. The ink jets are coupled to respective ink sources that are illustrated by 62, 64, 66 and 68. In a typical fashion, the inkjet inks or dyes can be of the additive or subtractive color types, or any other suitable color type or technique. In the illustrated example, four jet heads can be used to selectively supply the standard cyan, magenta, yellow and key (e.g., black) (CMYK) inks. In other embodiments, additive inks or dyes can be used such as red, green, blue (RGB), etc. Depending on the color approach used, there can be different numbers, types and arrangements of jets.

Printer head 60 and the arrangement of the jets on the surface of the printer head are such that the ink from the jets converges on the material bead 50 during printing to cover a desired point or portion 80 of the material 50. By having the jets converge their ink streams at the desired point, which can be smaller than the bead, the resolution of the printing can be finer than the bead resolution. Also, by allowing the streams (actually a droplet or series of droplets) from the jets to overlap it is possible to get from many to millions or more different colors by mixing the inks as is known in the art. Although the embodiments are discussed primarily with respect to applying ink to the material at or near to the time of printing, it should be apparent that it is also possible to apply ink at later times.

In one embodiment, the printer head is in a fixed relationship with the extruder head assembly 10 by using a coupling structure illustrated by 92. In other embodiments, the printer head can be made to move around the nozzle 40 so that only one or a few jet assemblies need be used to apply ink to different sides of the bead. In other embodiments, the printer head and/or the jets can be in a fixed relationship to the extruder housing and to the nozzle 40. In this case of a fixed printer head, the printer head can be constructed as a ring or spherical section around (partly or completely) the printer nozzle with different sets of jets pointing to different surface points on the bead.

In one approach, the printer head assembly does not extend below the line (that defines a plane) A-A′ of the tip of the 3D printer nozzle as shown in FIG. 1. Another definition of this plane can be the current “build plane” in which the nozzle is depositing a layer of material current build layer. This ensures that the printer head will not interfere with the current layer being printed, but also requires that the ink jet streams be pointed off the horizontal axis to accurately hit the material. Note that in other embodiments printing need not occur with the nozzle tip pointed downward. The nozzle may point upward or to the left or right or in any other orientation.

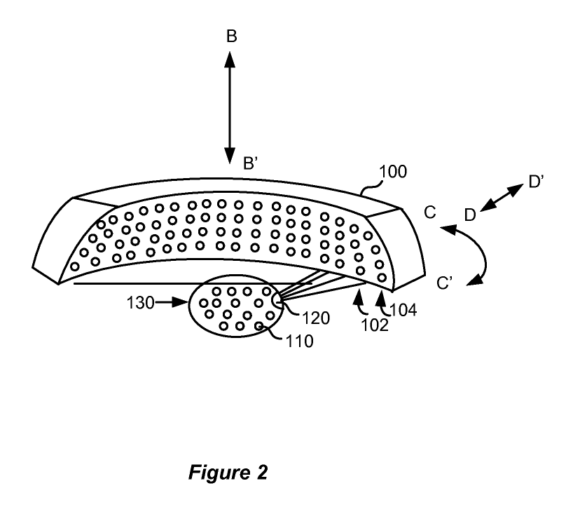

FIG. 2 illustrates a section 100 of a printer head that is fixed with respect to a bead 110 of material that has just been printed. This embodiment actually uses a complete ring of jets but only a section is shown for ease of illustration. Each column of jets such as 102 and 104 around the ring correspond to a single point 120 or dot to be supplied with ink. By providing a complete ring of jets, any of a number of points in a band 130 around the circumference of the bead can be color printed. Other bands of inking points on the material can also be colored by having multiple sets of jets on the printer head (either above, below, or adjacent to) the illustrated sets. Different configurations are possible such as by having the sets grouped horizontally rather than vertically, using clusters of jets in a diamond, square, triangle, or other pattern, etc.

In an embodiment where a printer head need not be stationary with respect to the nozzle tip, the printer head assembly can be controlled up or down in the B-B′ directions, or can be made to rotate about the bead in the C-C′ directions, or can be made to go nearer to, or farther away from, the bead in the D-D′ directions. Other movement of the printer head is possible and can depend on the shape of the printer head, the number and type of jets, the type of 3D printing, shape of an object being printed, etc.

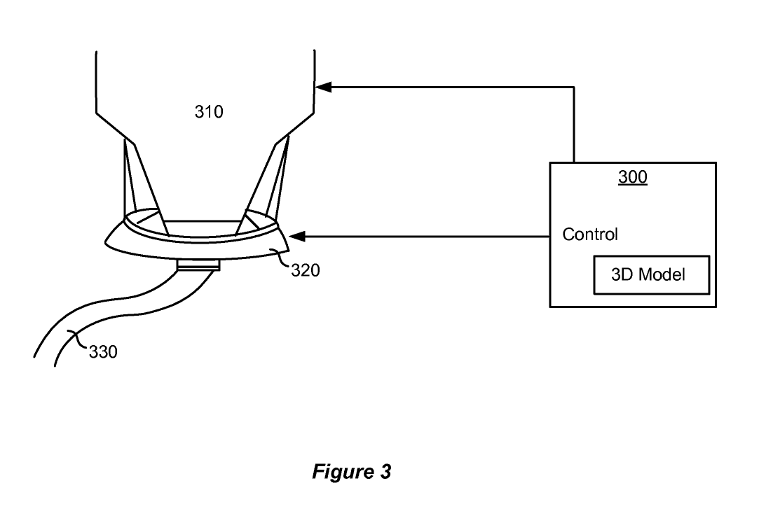

FIG. 3 illustrates a basic control scheme for an embodiment. In one approach, a controller 300 is used to control both the extruder 310 and the print head 320. As the bead is laid down, a “road” 330 or strip of material is formed. The controller is used to coordinate the selection and spraying of the ink from the appropriate jet(s) with the extrusion of material and movement of the 3D printer head. In one approach, the controller determines that ink is needed on an edge surface of the road. If the controller computes that the edge surface is sufficiently normal to a direction of ink from one or more of the ink jets then the controller triggers the appropriate jets to emit ink at the time and quantity calculated so that the ink impacts the material.

In other approaches it may not be necessary, or can even be more desirable to trigger jets that are off-axis to the surface normal of the point to be sprayed. This situation can arise, for example, when it is desired to use ink at an oblique angle to cause a feathering effect, cover more surface area, or where it is calculated that the translational movement of the extruder head is such that the desired point of material will fall under the stream of the jet in a desired manner. In other words, the controller can be programmed to take into account the “moving target” nature of the overall fabrication of the part. Since the controller is controlling both the extruder and the print head there are many types of efficiencies that can be realized by calculating the droplet projectiles from the jets and the movement of the extruder head and/or printer head.

Additional considerations can be the surface quality of the material that can be affected by temperature and texture and other factors. For example, if the ink does not apply well at higher temperatures then the ink need not be applied immediately as the material is deposited on a surface. The extruder can continue to deposit material and then the assembly can go back to the formerly deposited material for inking. Or, if the extruder head assembly can move independently from the ink assembly then the ink assembly can be controlled to apply ink at a predetermined time after the material has been extruded—calculated so that the material will be at a more desirable temperature for the application of ink.

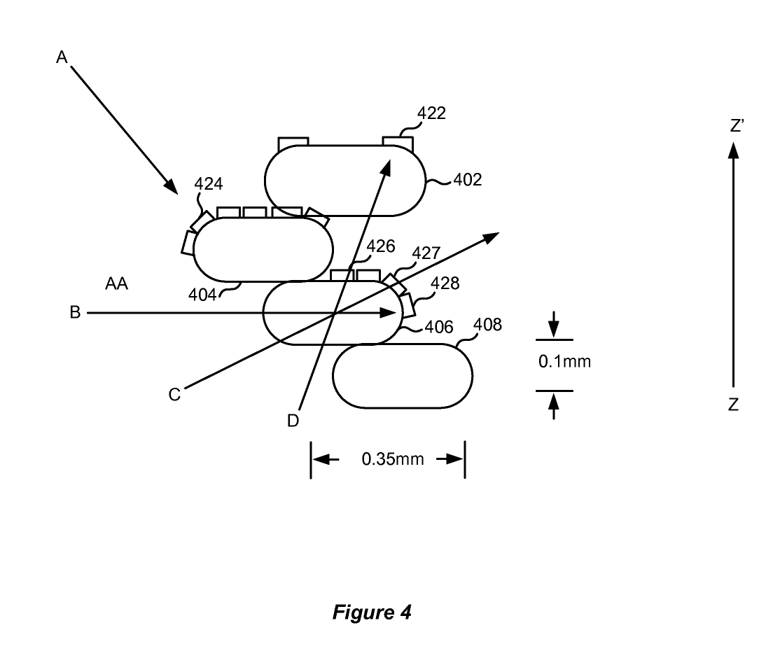

FIG. 4 shows a cross sectional view of 4 layers of extruded beads of 3d printed material. The beads may be 0.1 mm (in the direction of Z-Z′) and 0.35 mm wide (defined by a length and width in a layer plane of printing that is normal to Z-Z′). With present-day systems, the beads, or roads, may typically be 0.1 mm to 0.5 mm high and 0.2 mm to 0.5 mm wide. However, other dimensions are possible by changing such known parameters as the extrusion nozzle diameter, z-axis step increment, first layer position or height, nozzle shape, etc. The cross-sectional shape of the beads need not be oval and the shapes and dimensions can vary even within a single 3d print. The shape and dimensions presented here are given merely to provide an example and shapes and dimensions can vary in different embodiments and should not be taken as limiting the scope of the claims unless otherwise noted.

In FIG. 4, layers 402, 404, 406 and 408 are deposited one on top of the other. Typically, each layer is completed before the next successive (higher) layer is started but in other embodiments this need not be the case. Shown on a surface of some of the beads are ink droplets (or other types of dye or pigment depositions) such as droplet 422 on bead 402, droplet 424 on bead 404, and droplets 426 and 428 on bead 406. Rays A, B, C and D show example viewing rays of a human observer, or machine optical or imaging device, determining or sensing a color of the 3d printed shape at a particular point. In this particular embodiment, beads such as 402 and 406 are made from transparent or semi-transparent material (e.g., nylon (e.g. Taulman 618 nylon filament)) so that viewing of the color area defined by an ink droplet can be from a ray that passes through a bead. Different degrees of transparent or opaque material can be used and/or mixed, as desired. A color area may be, for example, 17.5 microns in diameter in a substantially circular pattern. Naturally, if an ink jet emitter is used, the shape and size of the color area can also vary depending upon the irregularity (i.e., non-planar) surface of the bead.

In FIG. 4, ray A impinges directly on color area 424 so that the color of 424 by itself can determine the color. It is also possible to calculate the color effects of the combination of the color area with the bead to determine the resulting visual effect or final color. Different combinations of color area color and other properties with bead color and bead properties can result in a better end result.

Ray B crosses through bead 406 and impinges color area 428. Thus, the viewing properties of both bead 406 and color area 428 determine the final viewing color and other properties seen along Ray B. Similarly, ray C passes through bead 406, color area 426, bead 402 and color area 422. Ray C passes through bead 406, color area 427 and can continue to ambient light (if there are no parts of the 3d printed shape in the way) or other external objects and viewing properties.

Thus, many combinations of achieving color, transparency, spatial (e.g., layered) viewing properties, reflections and other viewing effects are possible. These viewing effects can be mixed within a shape being printed and can use multiple materials, angles, combinations and other variations to achieve desired effects. For example, one effect can be to more accurately model human skin which looks different in different light sources and under different conditions. Another possibility is to show items under or within a surface such as veins inside a body, or a fish in a habitat, smoke particles suspended above or around an object, etd. Another useful application is where a color area cannot be suitably applied to one part of an object (e.g., to the outside of a face) because the angle and/or shape of a bead doesn't allow inkjet printing onto a bead's exposed exterior. In such a case, the bead can be made transparent and the interior of the bead can be applied with the desired color by taking into account any color attenuation or modification due to the light having to also pass through the bead material. With such compensation the interior color on the bead can be made to match the exterior color of the bead when the two are viewed together from the outside of the bead. For example, the colors as seen from ray A and from ray AA can be matched in this manner. Many known techniques for achieving colors or other visual effects can be used such as half-toning by using multiple color areas to create a perceived color that is a mix of the multiple color areas.

Although the description has been described with respect to particular embodiments thereof, these particular embodiments are merely illustrative, and not restrictive.

It should be apparent that many types of control schemes can be used. Any suitable programming language may be used to implement the routines of particular embodiments including C, C++, Java, assembly language, etc. Different programming techniques may be employed such as procedural or object-oriented. The routines may execute on a single processing device or on multiple processors. Although the steps, operations, or computations may be presented in a specific order, the order may be changed in particular embodiments. In some particular embodiments, multiple steps shown as sequential in this specification may be performed at the same time.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication or transfer of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, they are intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. An apparatus for applying a color area to a bead in a fused deposition type of 3D printing, the apparatus comprising:
a 3D print head; and
an ink head operated in coordination with the 3D print head to create color on the bead.

2. The apparatus of claim 1, further comprising:
a controller for triggering a jet on the ink head to apply ink to a point on the bead formed by the 3D print head.

3. The apparatus of claim 2, further comprising:
A nozzle for depositing material, wherein the ink head is maintained out of a build plane defined by the movement of the nozzle when the nozzle is depositing a layer of material.

4. The apparatus of claim 3, wherein the ink head is fixed with respect to the position of the nozzle.

5. The apparatus of claim 3, wherein the ink head can move independently of the position of the nozzle.

6. The apparatus of claim 1, wherein the ink head is formed substantially around the 3D print head.

7. The apparatus of claim 6, wherein the ink head includes multiple jets for creating a point of color by converging ink emitted from two or more of the multiple jets onto a portion of a bead of material created by the 3D print head.
